(19) United States
(12) Patent Application Publication
(10) Pub. No.: US 2008/0069514 A1
(43) Pub. Date: Mar. 20, 2008

(54) Method and apparatus for controlling time-shifting storage space and television receiver using the same

(75) Inventors: Ho-shin Son, Suwon-si (KR); Nam-soon Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/655,076

(22) Filed: Jan. 19, 2007

(30) Foreign Application Priority Data
Sep. 15, 2006 (KR) 10-2006-0089653

(51) Int. Cl. H04N 5/94

(52) U.S. Cl. 386/48

(57) ABSTRACT

A method and apparatus for controlling a time-shifting storage space, whereby the time-shifting storage space can be changed according to a size of a broadcasting program to be time shifted, and a television (TV) receiver using the same are provided. The method includes: determining whether a size change of the time-shifting storage space is necessary, and if it is determined that a size change of the time-shifting storage space is necessary, changing a size of the time-shifting storage space using a data storage space.

### CROSS-REFERENCE TO RELATED PATENT APPLICATION

This application claims priority from Korean Patent Application No. 10-2006-0089653, filed on Sep. 15, 2006, in the Korean Intellectual Property Office, the disclosure of which is incorporated herein in its entirety by reference.

### BACKGROUND OF THE INVENTION

1. Field of the Invention

Methods and apparatuses consistent with the present invention relate to control of a time-shifting storage space, and more particularly, to controlling a time-shifting storage space according to a size of a program to be recorded and a television (TV) receiver using the same.

2. Description of the Related Art

A time-shifting storage space is a storage space for a time-shift function, which is included in a device having a Personal Video Recorder (PVR) function. According to the time-shift function, when a play button is pressed after a predetermined time elapses from when a pause button is pressed while viewing a currently time-shifting program (or broadcasting program), the broadcasting program can be played from when the pause button is pressed. In addition, using the time-shift function, a user can replay a broadcasting program, play a broadcasting program in slow motion, or skip a boring portion.

Most devices having the PVR function use a hard disk drive (HDD) as a time-shifting storage space. However, related art devices having the time-shift function use a fixed capacity (or size) of a time-shifting storage space. Thus, when a program having a size greater than the size of a time-shifting storage space is time shifted, if the time-shifting storage space becomes full, the remaining program data is recorded by erasing previously recorded program data, and thus a user cannot view the entire program.

### SUMMARY OF THE INVENTION

The present invention provides a method and apparatus for controlling a time-shifting storage space, whereby the time-shifting storage space can be changed according to a size of a broadcasting program to be time shifted, and a TV receiver using the same.

The present invention also provides a method and apparatus for controlling a time-shifting storage space, whereby the time-shifting storage space can be changed according to a size of a broadcasting program to be time shifted based on Electronic Program Guide (EPG) information, and a TV receiver using the same.

According to an aspect of the present invention, there is provided a method of controlling a time-shifting storage space, the method comprising: determining whether a size change of the time-shifting storage space is necessary; and if it is determined that a size change of the time-shifting storage space is necessary, changing a size of the time-shifting storage spare using a data storage space.

The determining of whether a size change of the time-shifting storage space is necessary may comprise: determining whether a start time of a program exists in the time-shifting storage space; if it is determined that the start time of the program exists in the time-shifting storage space, determining whether a size change of the time-shifting storage space is necessary by comparing a running time of the program based on the start time and an end time of the program to a time-shifting time corresponding to the time-shifting storage space; and if it is determined that the start time of the program does not exist in the time-shifting storage space, determining whether a size change of the time-shifting storage space is necessary by comparing a running time of the program based on a time when the program started to be recorded in the time-shifting storage space and the end time of the program to the time-shifting time.

According to another aspect of the present invention, there is provided an apparatus for controlling a time-shifting storage space, the apparatus comprising: a storage unit having the time-shifting storage space and a data storage space; a determiner which determines whether a size change of the time-shifting storage space is necessary; and a controller which changes a size of the time-shifting storage space using the data storage space if it is determined that a size change of the time-shifting storage space is necessary.

The determiner may determine whether a size change of the time-shifting storage space is necessary, using a running time of a program based on a start time and an end time of the program and a time-shifting time corresponding to the time-shifting storage space, if the start time of the program exists in the time-shifting storage space, and the determiner may determine whether a size change of the time-shifting storage space is necessary, using the running time of the program based on a time when the program started to be recorded in the time-shifting storage space and the end time of the program, and the time-shifting time, if the start time of the program does not exist in the time-shifting storage space.

According to another aspect of the present invention, there is provided a TV receiver having a time shift function, the TV receiver comprising: a storage unit having a time-shifting storage space and a data storage space; a determiner which determines whether a size change of the time-shifting storage space is necessary, based on at least one of a running time of a program to be recorded in the time-shifting storage space and time-shifting time information input by a user; and a controller which changes a size of the time-shifting storage space using the data storage space if it is determined that a size change of the time-shifting storage space is necessary, wherein the running time of the program is obtained based on EPG information and a time when the program started to be recorded in the time-shifting storage space.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of an apparatus for controlling a time-shifting storage space according to an exemplary embodiment of the present invention;

FIG. 2 illustrates a storage space configuration of a storage unit illustrated in FIG. 1, according to an exemplary embodiment of the present invention;

FIG. 3 is a diagram for describing a correlation between Electronic Program Guide (EPG) information and a time-shifting storage space according to an exemplary embodiment of the present invention;

FIG. 4 is a diagram for describing a correlation between an expanded time-shifting storage space and a data storage space according to an exemplary embodiment of the present invention;

FIG. 5 is a block diagram of a digital TV (DTV) receiver including an apparatus for controlling a time-shifting storage space according to an exemplary embodiment of the present invention;

FIG. 6 is a flowchart illustrating a method of controlling a time-shifting storage space according to an exemplary embodiment of the present invention;

FIG. 7 is a flowchart illustrating a process of determining whether a size change of the time-shifting storage space is necessary, which is illustrated in FIG. 6, according to an exemplary embodiment of the present invention;

FIG. 8 is a flowchart illustrating a method of controlling a time-shifting storage space according to another exemplary embodiment of the present invention;

FIG. 9 is a flowchart illustrating a method of controlling a time-shifting storage space according to another exemplary embodiment of the present invention;

FIG. 10 is a flowchart illustrating a method of controlling a time-shifting storage space according to another exemplary embodiment of the present invention; and

FIG. 11 is a flowchart illustrating a process of determining whether a size change of the time-shifting storage space is necessary, which is illustrated in FIG. 6, according to another exemplary embodiment of the present invention.

### DETAILED DESCRIPTION OF EXEMPLARY EMBODIMENTS

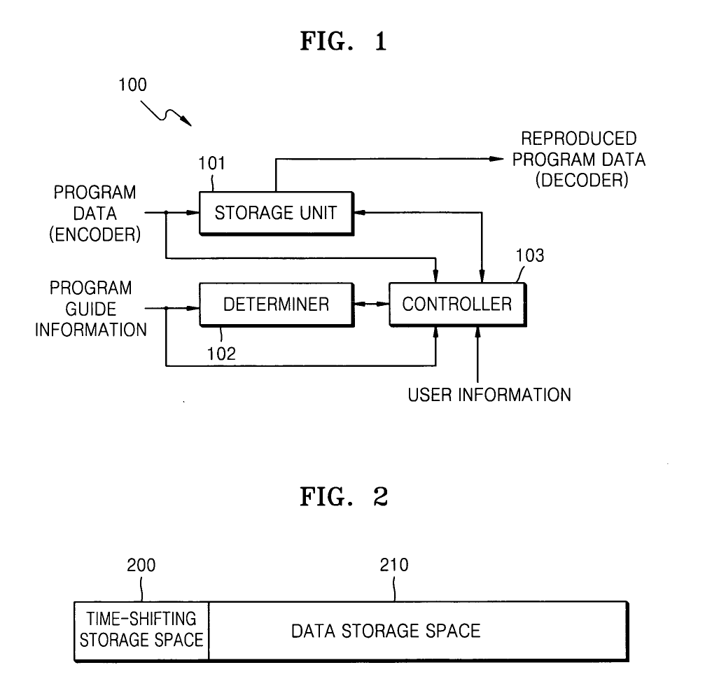

FIG. 1 is a block diagram of an apparatus 100 for controlling a time-shifting storage space according to an exemplary embodiment of the present invention. Referring to FIG. 1, the apparatus 100 includes a storage unit 101, a determiner 102, and a controller 103.

The storage unit 101 has a time-shifting storage space 200 and a data storage space 210 illustrated in FIG. 2. The time-shifting storage space 20Q is a previously reserved space for time shift. The data storage space 210 is a space for recording a program to be recorded using a reservation recording function or user's content. The user's content is content input by a user and, for example, may be content comprised of still images, video, or music or may have a file format. The data storage space 210 can be defined as an available space.

The time-shifting storage space 200 and the data storage space 210 can be physically or logically divided spaces in the storage unit 101.

The determiner 102 determines whether a size change of the time-shifting storage space 200 in the storage unit 101 is necessary. That is, when the controller 103 informs the determiner 102 that the time-shifting storage space 200 in the storage unit 101 is in a full state, the determiner 102 determines whether a start time of a currently time-shifting program is included in the time-shifting storage space 200. This can be determined using a time when a program started to be recorded in the time-shifting storage space 200 and the start time of the currently time-shifting program. The time when a program started to be recorded in the time-shifting storage space 200 can be provided by the controller 103. The start time of the currently time-shifting program is obtained from received program guide information. The program guide information is information received together with a broadcasting program and may be EPG information.

If it is determined that the start time of the currently time-shifting program is included in the time-shifting storage space 200, the determiner, 102 determines whether a size change of the time-shifting storage space 200 is necessary, using a running time of the currently time-shifting program based on the start time and an end time of the currently time-shifting program and a time-shifting time corresponding to the time-shifting storage space 200. The start time and the end time of the currently time-shifting program are obtained from the received program guide information. The time-shifting time can be provided by the controller 103. The controller 103 can calculate the time-shifting time based on a default size of the time-shifting storage space 200.

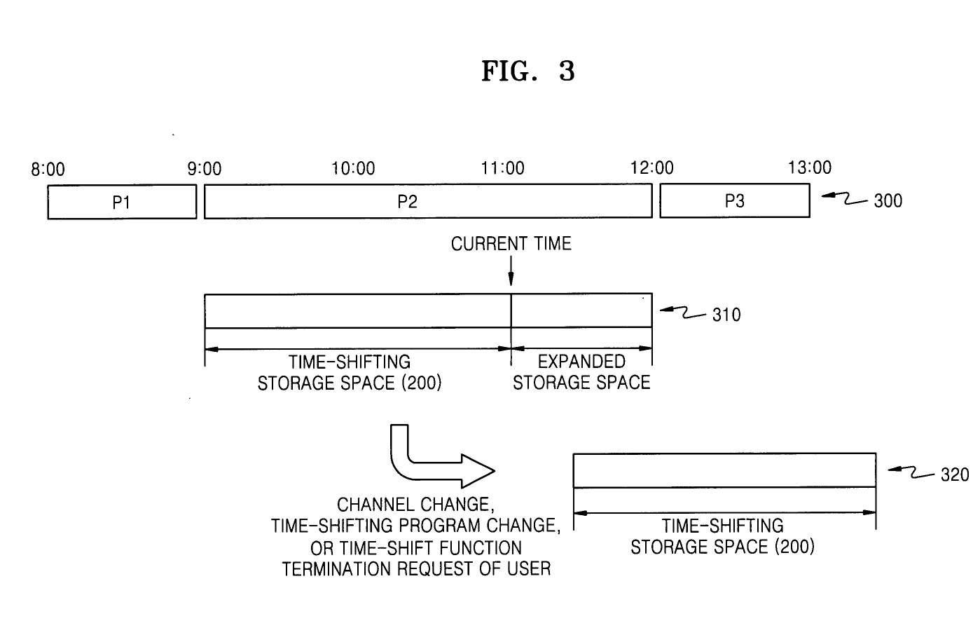

If the running time of the currently time-shifting program is longer than the time-shifting time, the determiner 102 determines that a size change of the time-shifting storage space 200 is necessary. For example, as illustrated in reference numeral 300 of FIG. 3, if a start time of a currently time-shifting program P2 is 9:00 and an end time is 12:00, a running time of the currently time-shifting program P2 is three hours. In this case, if a time-shifting time of the time-shifting storage space 200 is two hours as illustrated in reference numeral 310 of FIG. 3, the determiner 102 determines that a size change of the time-shifting storage space 200 is necessary.

Unlike that illustrated in reference numeral 300 of FIG. 3, if a start time of a currently time-shifting program is 9:00 and an end time is 11:00, a running time of the currently time-shifting program is two hours. In this case, if a time-shifting time of the time-shifting storage space 200 is two hours as illustrated in reference numeral 310 of FIG. 3, the determiner 102 determines that a size change of the time-shifting storage space 200 is unnecessary. As described above, if a running time of a program is equal to or shorter than a time-shifting time, the determiner 102 determines that a size change of the time-shifting storage space 200 is unnecessary.

If it is determined that the start time of the currently time-shifting program is not included in the time-shifting storage space 200, the determiner 102 determines whether a size change of the time-shifting storage space 200 is necessary, using a running time of the currently time-shifting program based on a time when the currently time-shifting program started to be recorded in the time-shifting storage space 200 and an end time of the currently time-shifting program, and a time-shifting time corresponding to the time-shifting storage space 200. The start time of the currently time-shifting program is not included in the time-shifting storage space 200 when the time shift for the currently time-shifting program starts due to a channel change after the currently time-shifting program has started. Thus, the time when the currently time-shifting program started to be recorded in the time-shifting storage space 200 can be a channel change time.

Likewise, if a running time of the currently time-shifting program is longer than a time-shifting time, the determiner 102 determines that a size change of the time-shifting storage space 200 is necessary. However, if the running time of the currently time-shifting program is equal to or shorter than the time-shifting time, the determiner 102 determines that a size change of the time-shifting storage space 200 is unnecessary. The determination result is provided to the controller 103.

If the determination result provided by the determiner 102 indicates that a size change of the time-shifting storage space 200 is necessary, the controller 103 changes a size of the time-shifting storage space 200 using the data storage space 210.

To do this, the controller 103 monitors a size of program data to be stored in the time-shifting storage space 200 of the storage unit 101 based on size information of the time-shifting storage space 200. The size information of the time-shifting storage space 200 can be previously set. If the size of program data to be stored in the time-shifting storage space 200 reaches the size information of the time-shifting storage space 200 as the monitoring result, the controller 103 informs the determiner 102 that the time-shifting storage space 200 is in the full state. In this case, the controller 103 may provide information on a time-shifting time corresponding to the time-shifting storage space 200 to the determiner 102.

If the determination result provided by the determiner 102 indicates that a size change of the time-shifting storage space 200 is unnecessary, the controller 103 does not change the size of the time-shifting storage space 200. However, if the determination result provided by the determiner 102 indicates that a size change of the time-shifting storage space 200 is necessary, the controller 103 dynamically changes the size of the time-shifting storage space 200 according to the running time of the currently time-shifting program. The running time of the currently time-shifting program can be provided to the determiner 102 or obtained from the controller 103 based on the program guide information.

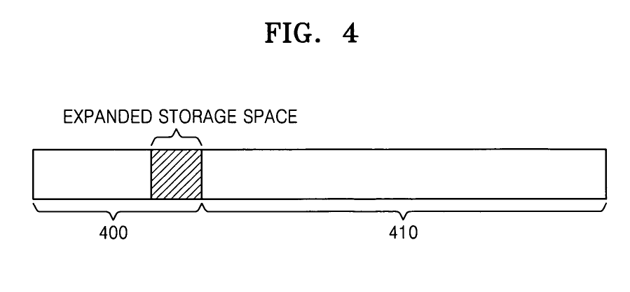

That is, if the running time of the currently time-shifting program P2 is three hours as illustrated in reference numeral 300 of FIG. 3, and if the time-shifting time of the time-shifting storage space 200 is two hours as illustrated in reference numeral 310 of FIG. 3, the controller 103 expands the size of the time-shifting storage space 200 as illustrated in reference numeral 310 of FIG. 3 so that a storage space corresponding to a time-shifting time of one hour among the data storage space 210 of FIG. 2 is added to the time-shifting storage space 200. Thus, the data storage space 210 is reduced by an amount of the storage space corresponding to the time-shifting time of one hour. As a result, the time-shifting storage space and the data storage space of the storage unit 101 are re-defines as illustrated in FIG. 4.

FIG. 4 illustrates a structure of the storage unit 101 in which the size of the time-shifting storage space 200 is expanded. Reference numeral 400 denotes a time-shifting storage space to which an expanded storage space is added, and reference numeral 410 denotes a data storage space from which a storage space is reduced. The expanded storage space and the existing time-shifting storage space 200, which are illustrated in FIG. 4, can be physically or logically adjacent storage spaces.

The controller 103 can determine whether an available space exists in the-data storage space 210, before the size of the time-shifting storage spate 200 is expanded. If it is determined that an available space does not exist in the data storage space 210, the controller 103 can inform the user that an available space does not exist in the data storage space 210. The controller 103 can inform the user of this using a user interface (UI: not shown) or a display unit (not shown) for displaying a program. If it is determined that an available space exists in the data storage space 210, the controller 103 expands the time-shifting storage space 200 based on the available space as described above.

After the size of the time-shifting storage space 200 is expanded, if a channel is changed by input user information, termination of the time shift function is requested, or a program being recorded in the time-shifting storage space 200 is changed, the controller 103 changes the size of the time-shifting storage space 200 to the default size illustrated in 320 of FIG. 3. Thereafter, the controller 103 controls a size change of the time-shifting storage space 200 using a running time of a newly time-shifting program and the time-shifting time corresponding to the time-shifting storage space 200 changed to the default size as described above.

If time-shifting time information input by the user and time-shifting time information corresponding to the time-shifting storage space 200 are received from the controller 103, the determiner 102 can also perform the determination. This is a case where the size of the time-shifting storage space 200 is manually changed by the user. In this case, the determiner 102 can be included in the controller 103.

In FIG. 1, user information can be input through the UI, a remote control, or a function button assembled with a front panel of the apparatus 100.

The apparatus 100 illustrated in FIG. 1 can be applied to PVRs and DTV receivers having the PVR function.

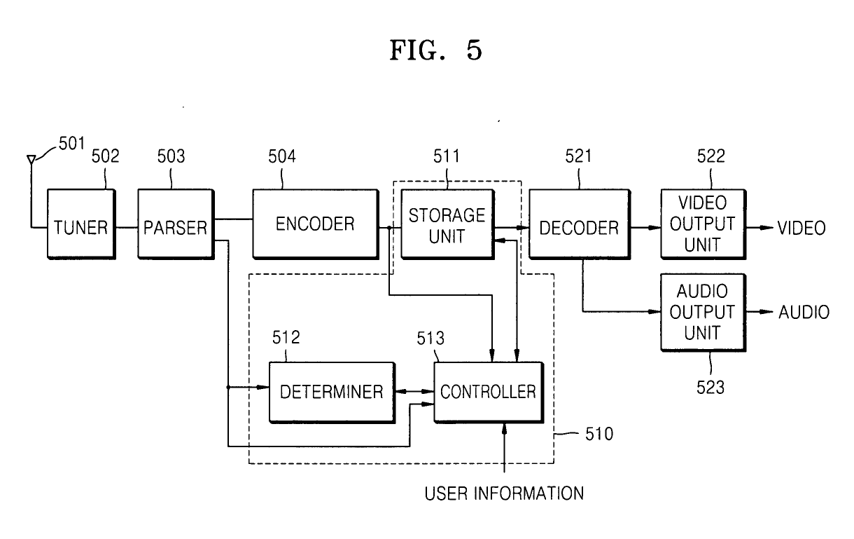

FIG. 5 is a block diagram of a DTV receiver including an apparatus for controlling a time-shifting storage space according to an exemplary embodiment of the present invention. Referring to FIG. 5, the DTV receiver includes an antenna 501, a tuner 502, a parser 503, an encoder 504, an apparatus 510 for controlling a time-shifting storage space according to an exemplary embodiment of the present invention, a decoder 521, a video output unit 522, and an audio output unit 523.

If a broadcasting program to be time-shifted is received through the antenna 501 and the tuner 502, the parser 503 parses the broadcasting program and additional information. The additional information includes EPG information. The broadcasting program is transmitted to the encoder 504, and the EPG information of the additional information is transmitted to the apparatus 510. That is, the EPG information is provided to a determiner 512 and a controller 513.

The encoder 504 compresses the input broadcasting program. The compressed broadcasting program is provided to the apparatus 510. The apparatus 510 stores the compressed broadcasting program in a storage unit 511 while dynamically changing a size of a time-shifting storage space based on one of a running time of the time-shifting program and time-shifting time information input by a user as described in FIGS. 1 through 4.

The decoder 521 decodes the compressed broadcasting program output from the storage unit 511. A decoded video signal is transmitted to the video output unit 522, and a decoded audio signal is transmitted to the audio output unit 523. The video output unit 522 outputs the video signal outside the DTV receiver, and the audio output unit 523 outputs the audio signal outside the DTV receiver.

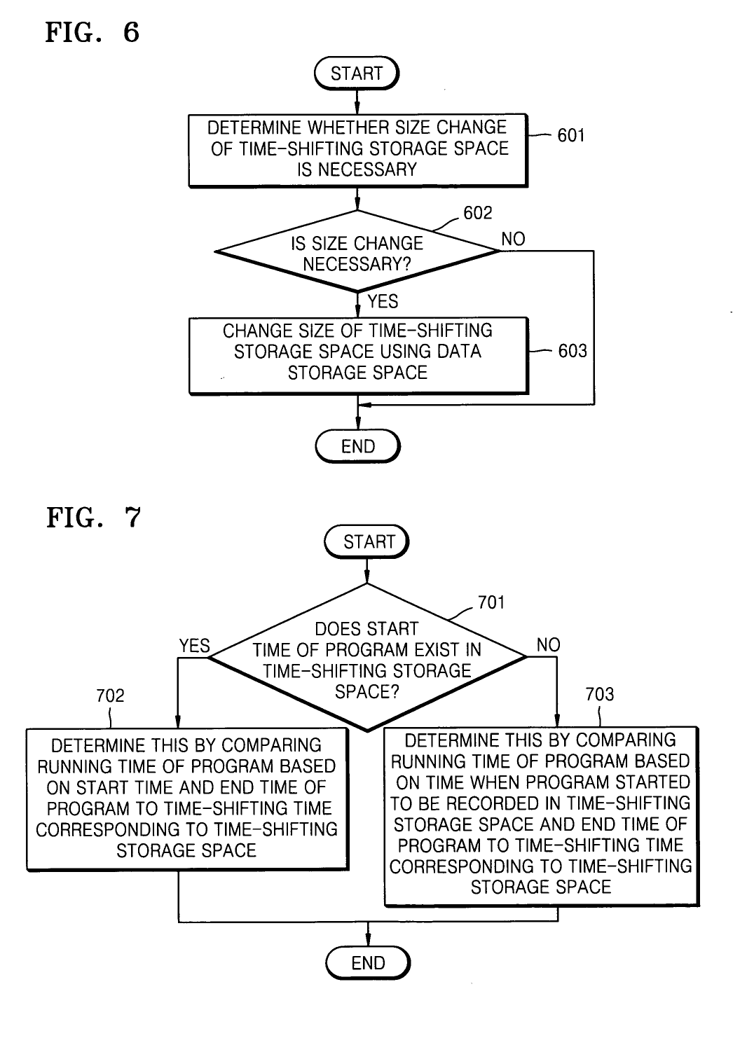

FIG. 6 is a flowchart illustrating a method of controlling a time-shifting storage space according to an exemplary embodiment of the present invention.

Referring to FIG. 6, it is determined in operation 601 whether a size change of the time-shifting storage space is necessary. Whether a size change of the time-shifting storage space is necessary can be determined as illustrated in FIG. 7.

FIG. 7 is a flowchart illustrating operation 601 illustrated in FIG. 6, according to an exemplary embodiment of the present invention. Referring to FIG. 7, it is determined in operation 701 whether a start time of a program exists in the time-shifting storage space. Whether the start time of the program exists in the time-shifting storage space can be determined as illustrated in the description of the determiner 101 of FIG. 1.

If it is determined in operation 701 that the start time of the program exists in the time-shifting storage space, it is determined in operation 702 whether a size change of the time-shifting storage space is necessary, by comparing a running time of the program based on the start time and an end time of the program to a time-shifting time corresponding to the time-shifting storage space. The running time of the program and the time-shifting time can be obtained as described in FIG. 1.

If it is determined in operation 701 that the start time of the program does not exist in the time-shifting storage space, it is determined in operation 703 whether a size change of the time-shifting storage space is necessary, by comparing a running time of the program based on a time when the program started to be recorded in the time-shifting storage space and the end time of the program to the time-shifting time. The time when the program started to be recorded in the time-shifting storage space may be a channel change time or be obtained as described in FIG. 1.

Referring back to FIG. 6, as a result determined in operation 601, it is determined in operation 602 that a size change of the time-shifting storage space is necessary, a size of the time-shifting storage space is changed using a data storage space in operation 603. The time-shifting storage space and the data storage space have a correlation as illustrated in the description of the storage unit 101 of FIG. 1. The size change of the time-shifting storage space can be dynamically changed using the data storage space according to the running time of the program described above.

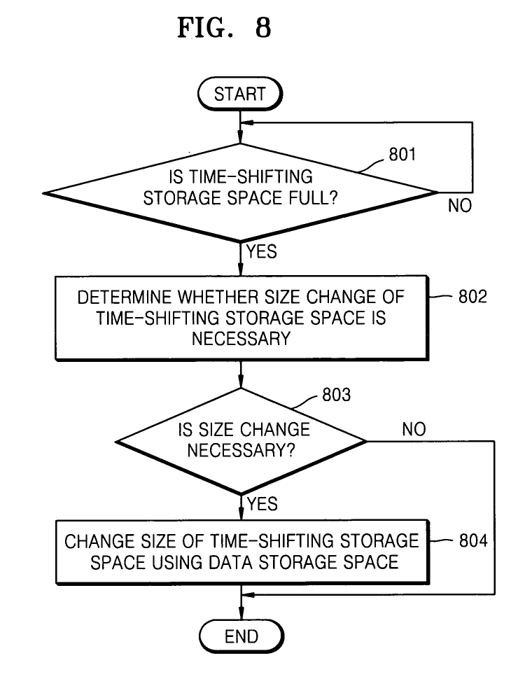

FIG. 8 is a flowchart illustrating a method of controlling a time-shifting storage space according to another exemplary embodiment of the present invention. FIG. 8 illustrates a case where if it is determined that the time-shifting storage space is in the full state, the method of controlling a time-shifting storage space, which is illustrated in FIG. 6, is performed. Thus, it is determined in operation 801 whether the time-shifting storage space is in the full state. Whether the time-shifting storage space is in the full state can be determined as illustrated in the description of the controller 103 of FIG. 1.

If it is determined in operation 801 that the time-shifting storage space is in the full state, the method according to the current exemplary embodiment controls the time-shifting storage space by performing operations 802 through 804 corresponding to operations 601 through 603 of FIG. 6.

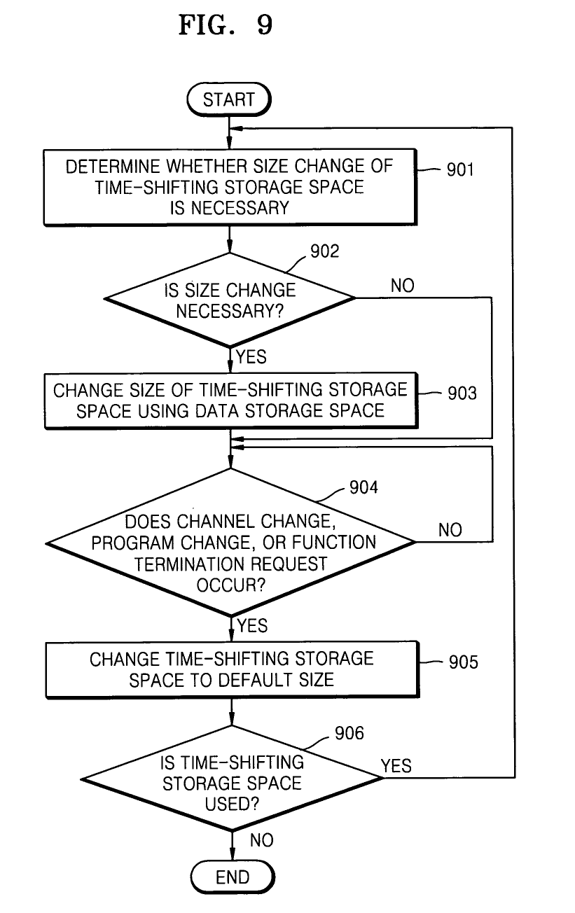

FIG. 9 is a flowchart illustrating a method of controlling a time-shifting storage space according to another exemplary embodiment of the present invention. FIG. 9 illustrates a case where after the size of the time-shifting storage space is changed as illustrated in FIG. 6, if a channel is changed, termination of the time shift function is requested, or a program being recorded in the time-shifting storage space is changed, the size of the time-shifting storage space is changed to a default size.

Thus, operations 901 through 903 of FIG. 9 are similar to operations 601 through 603 of FIG. 6.

It is determined in operation 904 whether a channel change, a change of a time-shifting program, or a termination request of time shift function occurs. If it is determined in operation 904 that a channel change, a change of a time-shifting program, or a termination request of time shift function occurs, the size of the time-shifting storage space is changed to the default size in operation 905.

It is determined in operation 906 whether the time-shifting storage space is being used. If it is determined in operation 906 that the time-shifting storage space is being used, the process returns to operation 901 to repeat the above-described procedures. If it is determined in operation 906 that the time-shifting storage space is not used, the process ends.

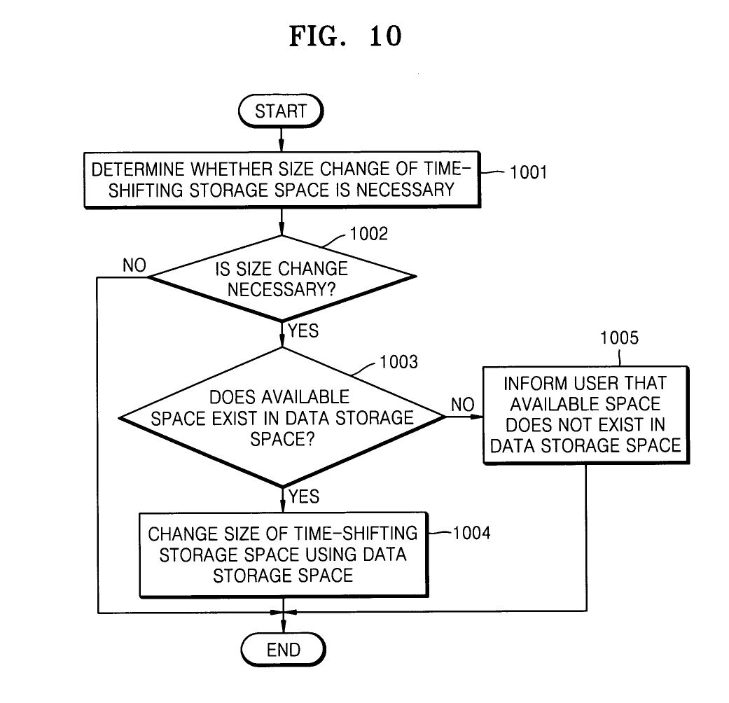

FIG. 10 is a flowchart illustrating a method of controlling a time-shifting storage space according to another exemplary embodiment of the present invention. FIG. 10 illustrates a case where when the size of the time-shifting storage space is changed as illustrated in FIG. 6, determining whether an available space exists in a data storage space is further included.

Thus, operations 1001 and 1002 of FIG. 10 are similar to operations 601 and 602 of FIG. 6.

If it is determined in operation 1002 that a size change of the time-shifting storage space is necessary, it is determined in operation 1003 whether an available space exists in the data storage space. To do this, a file system of the storage unit 101 can be used. If it is determined in operation 1003 that an available space exists in the data storage space, the size of the time-shifting storage space is changed in operation 1004 as illustrated in operation 603 of FIG. 6.

If it is determined in operation 1003 that an available space does not exist in the data storage space, a user is informed in operation 1005 that an available space does not exist in the data storage space, and the process ends. The notice to the user can be achieved using a UI method or a video or audio output method.

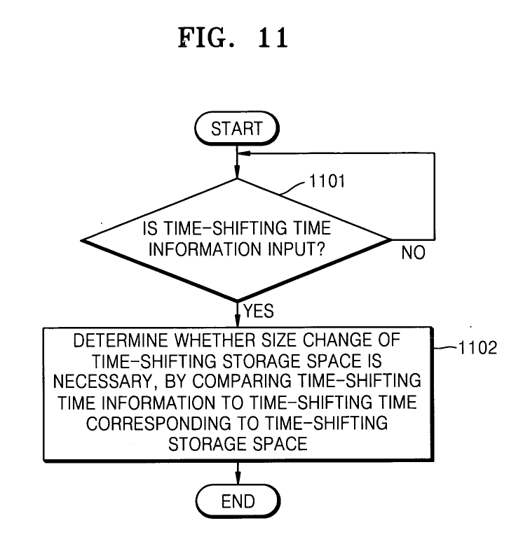

FIG. 11 is a flowchart illustrated in operation 601 of FIG. 6, according to another embodiment of the present invention. FIG. 11 illustrates a case where it is determined based on a time-shifting time input by a user whether a size change of the time-shifting storage space is necessary.

Referring to FIG. 11, it is determined in operation 1101 whether time-shifting time information is input by a user. If it is determined in operation 1101 that time-shifting time information is input by the user, it is determined in operation 1102 whether a size change of the time-shifting storage space is necessary, by comparing the time-shifting time information input by the user to a time-shifting time corresponding to the time-shifting storage space.

The present invention can be implemented so as for a user to selectively use the method of controlling a time-shifting storage space using EPG information or the method of controlling a time-shifting storage space using time-shifting time information input by the user.

The invention can also be embodied as computer readable codes on a computer readable-recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

As described above, according to the exemplary embodiments of the present invention, since a size of a time-shifting storage space can be dynamically changed using a data storage space in a device having a time shift function, the entire time-shifting program can be viewed again at any time regardless of a size of the time-shifting program.

While this invention has been particularly shown and described with reference to the exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of controlling a time-shifting storage space, the method comprising:
determining whether a size change of the time-shifting storage space is necessary; and
if it is determined that a size change of the time-shifting storage space is necessary, changing a size of the time-shifting storage space using a data storage space.

2. The method of claim 1, wherein the determining of whether a size change of the time-shifting storage space is necessary comprises:
determining whether a start time of a program exists in the time-shifting storage space;
if it is determined that the start time of the program exists in the time-shifting storage space, determining whether a size change of the time-shifting storage space is necessary by comparing a running time of the program based on the start time and an end time of the program to a time-shifting time corresponding to the time-shifting storage space; and
if it is determined that the start time of the program does not exist in the time-shifting storage space, determining whether a size change of the time-shifting storage space is necessary by comparing a running time of the program based on a time when the program started to be recorded in the time-shifting storage space and the end time of the program to the time-shifting time.

3. The method of claim 2, wherein the changing of the size of the time-shifting storage space comprises dynamically changing the size of the time-shifting storage space according to the running time of the program.

4. The method of claim 2, wherein the time when the program started to be recorded in the time-shifting storage space comprises a channel change time.

5. The method of claim 2, wherein if the time-shifting storage space is in a full state, it is determined whether a size change of the time-shifting storage space is necessary.

6. The method of claim 1, further comprising changing the size of the time-shifting storage space to a default size if a channel is changed, a termination of the time-shifting storage space is requested, or the program being recorded in the time-shifting storage space is changed, after the size of the time-shifting storage space is changed.

7. The method of claim 1, further comprising if it is determined that a size change of the time-shifting storage space is necessary, determining whether an available space exists in the data storage space, before the size of the time-shifting storage space is changed.

8. The method of claim 1, wherein the size change of the time-shifting storage space comprises expansion of the time-shifting storage space.

9. The method of claim 1, wherein the determining of whether a size change of the time-shifting storage space is necessary is performed based on a time-shifting time input by a user and a time-shifting time corresponding to the time-shifting storage space.

10. An apparatus for controlling a time-shifting storage space of a storage unit, the apparatus comprising:
a determiner which determines whether a size change of the time-shifting storage space is necessary; and
a controller which changes a size of the time-shifting storage space using a data storage space of the storage unit if it is determined that a size change of the time-shifting storage space is necessary.

11. The apparatus of claim 10, wherein if the time-shifting storage space is in a full state, the determiner operates.

12. The apparatus of claim 10, wherein the determiner determines whether a size change of the time-shifting storage space is necessary, using a running time of a program based on a start time and an end time of the program and a time-shifting time corresponding to the time-shifting storage space, if the start time of the program exists in the time-shifting storage space, and
wherein the determiner determines whether a size change of the time-shifting storage space is necessary, using the running time of the program based on a time when the program started to be recorded in the time-shifting storage space and the end time of the program, and the time-shifting time, if the start time of the program does not exist in the time-shifting storage space.

13. The apparatus of claim 12, wherein the time when the program started to be recorded in the time-shifting storage space comprises a channel change time.

14. The apparatus of claim 12, wherein the controller dynamically changes the size of the time-shifting storage space according to the running time of the program.

15. The apparatus of claim 10, wherein if a channel is changed, termination of the time-shifting storage space is requested, or the program being recorded in the time-shifting storage space is changed, the controller changes the size of the time-shifting storage space to a default size.

16. The apparatus of claim 10, wherein the time-shifting storage space is a reserved space for time shift in the storage unit, and the data storage space is a space for recording a program or content of a user.

17. The apparatus of claim 16, wherein the time-shifting storage space and the data storage space are physically divided spaces in the storage unit.

18. The apparatus of claim 16, wherein the time-shifting storage space and the data storage space are logically divided spaces in the storage unit.

19. The apparatus of claim 10, wherein if a time-shifting time is input by the user, the determiner determines whether a size change of the time-shifting storage space is necessary, based on the time-shifting time input by the user and time-shifting time information corresponding to the time-shifting storage space.
